(19) United States
(12) Patent Application Publication
(10) Pub. No.: US 2002/0013909 A1
(43) Pub. Date: Jan. 31, 2002

(54) Method of dynamic determination of access rights

(76) Inventors: Markus Baumeister, Aachen (DE); Steffen Hauptmann, Aachen (DE); Karin Klabunde, Aachen (DE)

Correspondence Address: U.S. Philips Corporation, 580 White Plains Road, Tarrytown, NY, 10591, US

(21) Appl. No.: 09/841,965

(22) Filed: Apr. 25, 2001

(30) Foreign Application Priority Data
Apr. 29, 2000 (DE) 10021222.0

(51) Int. Cl. H04L 12/22; H04L 9/32

(52) U.S. Cl. 713/201; 713/153; 709/229

(57) ABSTRACT

The invention relates to a network comprising terminals and a software system distributed over all the terminals. The software system contains at least an access controlled object (14) and a filter (9) which filter is provided for determining the access rights of a user for an access controlled object (14).

The invention relates to a network comprising terminals and a software system distributed over all the terminals.

Such a network is known from Ralf Steinmetz (Publ.): “Kommunikation in verteilten Systemen (Kivs)”, 11^{th} ITG/GI Symposium, Darmstadt, 2-5 May 1999; Stephan Abramowsky, Heribert Baldus, Tobias Helbig: “Digitale Netze in Wohnungen—Unterhaltungselektronik im Umbruch”, pp. 340 to 351. In this publication requirements are described for a future network in the home range with the software used therein. How access limitations are realized in such a network with a distributed software system is not further described therein.

It is an object of the invention to provide a network with a software system in which network the access rights of the user can be determined.

The object is achieved by a network of the type defined in the opening paragraph,

in that the network comprises at least an access controlled object and

in that the software system includes at least a filter which is provided for evaluating the access rights of a user for an access controlled object based on data which are not available until the time of access.

If a user or a member of a user group accesses an access controlled object of the network, a test is made by means of a filter whether this access is permissible. In this way, certain objects, for example devices, contents, such as films or applications, can be protected against undesired accesses by users. The much-desired protection against uncontrollable accesses to the network by children can be provided by the filter.

For evaluating the access conditions, the filter needs certain data. These data are supplied to the filter, for example, in the form of parameters of a message and can cause the filter to change the access rights. A child may be stopped from accessing a television set, for example, if the maximum time for the use of the television set is reached.

After the use by an application, a method call is sent to a software component referred to as the resource manager which manages resources such as devices, contents, useful data, management data, applications and can arrange for the access rights to be checked. The resource manager finds out that an access controlled object is to be accessed and therefore the access rights are to be adhered to. For this reason, the resource manager causes, by a method call, a software component referred to as an access right manager to check the user's access rights to the desired object. If the access right manager detects via a data structure, for example, in the form of a tree or list, that the use of a filter is necessary, the filter is activated by a method.

The tree necessary for checking the access rights comprises a plurality of nodes in which the users having the permitted use of a respective access-limited object are defined.

These and other aspects of the invention are apparent from and will be elucidated with reference to the embodiment(s) described hereinafter.

In the drawings:

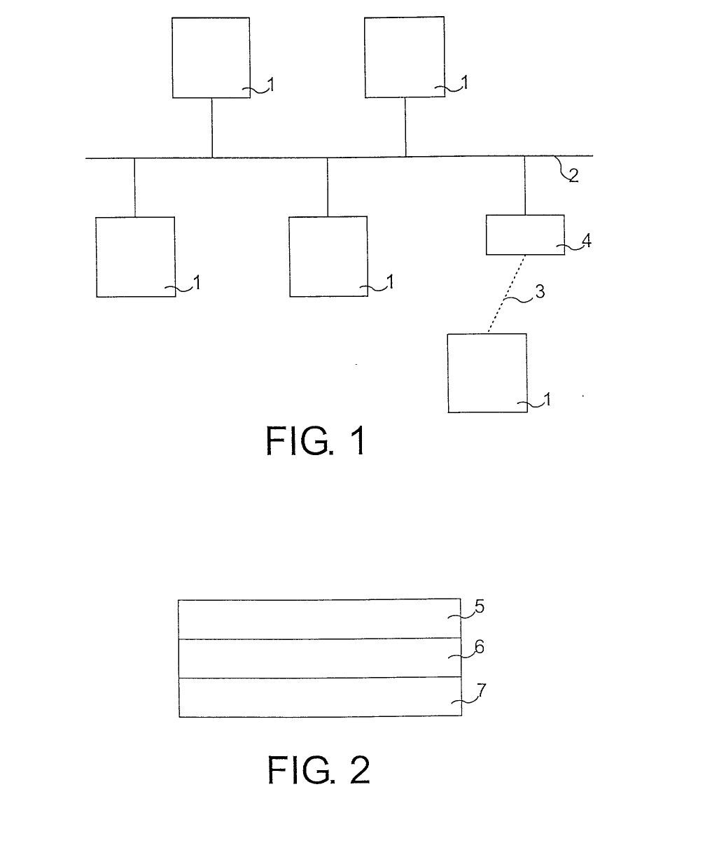

FIG. 1 shows a network comprising a plurality of terminals,

FIG. 2 shows various software levels of the software system used in the network,

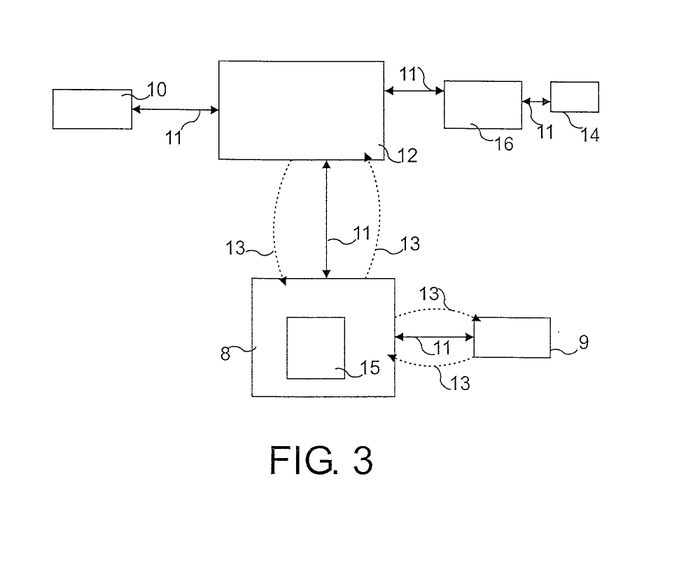

FIG. 3 gives a basic/functional representation of a filter,

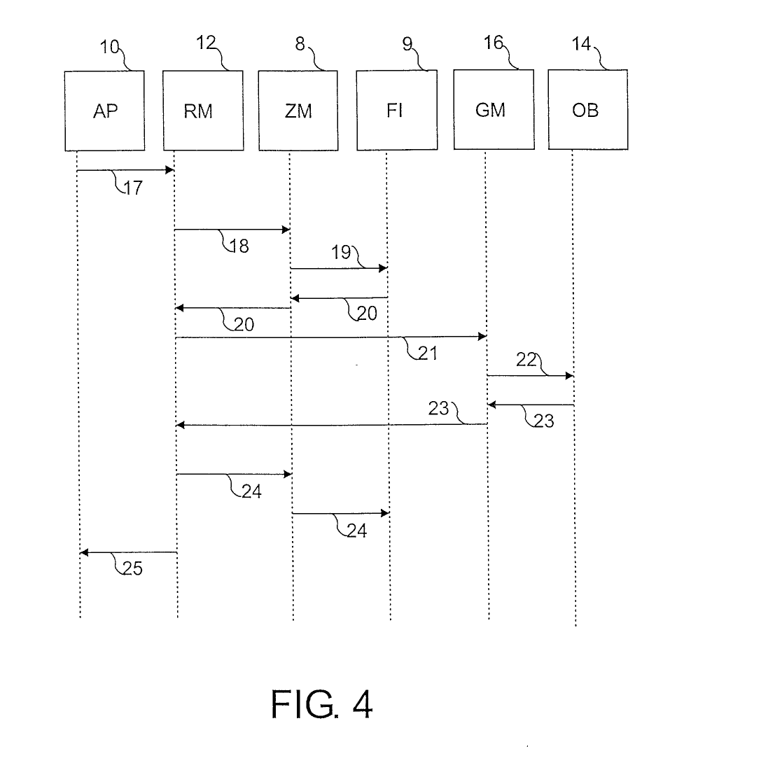

FIG. 4 shows a sign generator flow chart for representing over time the sequence of actions during a resource reservation,

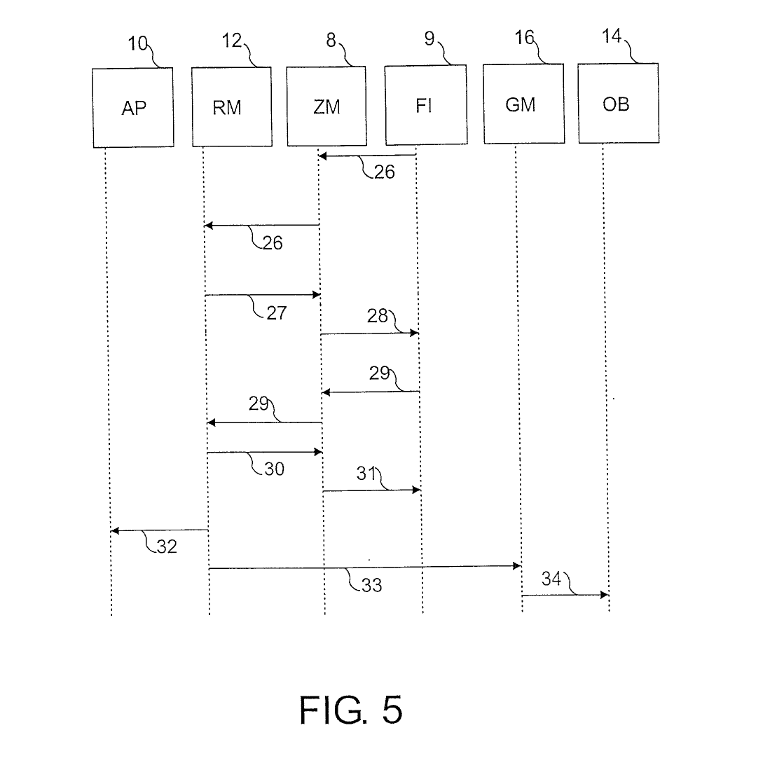

FIG. 5 shows a sign generator flow chart for the representation over time of the sequence of actions during a withdrawal of the access rights, and

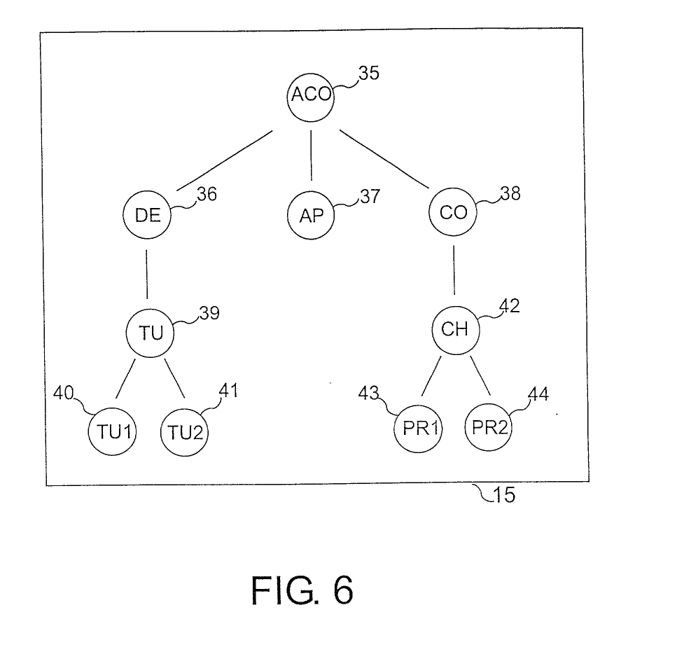

FIG. 6 shows the software structure or data structure respectively, of the objects in the form of a tree.

FIG. 1 shows a network, which interconnects various terminals 1 via a bus system 2. The terminals 1 may also be coupled to the bus system 2 by a wireless link 3 and a transceiver station 4. For example, infrared, ultrashell or radio links can be used for this purpose. Such terminals may be, for example, PCs and devices of entertainment electronics such as, for example a television set, set top box, tuner, camera, digital video recorder, CD player.

The user starts a desired application in the network from a terminal 1 with the aid of a software system distributed over all the terminals 1.

FIG. 2 shows the software system, which consists of various software levels which apply to the operating system. The top software level is an application level 5. The next software level is an infrastructure level 6 and the bottom software level is a network level 7.

The infrastructure level 6, having software components for the infrastructure management, includes an access right manager 8 and a filter 9, which filter is a program code for the dynamic determination and evaluation of the access rights (FIG. 3). Access rights relating to, for example, the use, change and erasure, and do not depend on dynamic magnitudes, can be statically laid down in the front-end. Other access rights, which depend on dynamic magnitudes such as the cost limitation for Internet access, time limits for television or limitations of the access to certain contents, cannot be determined in the front-end and, furthermore, the access conditions may change during the access. An enumeration of all the objects for which an access is prohibited or allowed respectively, is impossible in several cases (for example, all the permitted films), as a result of which the access rights are checked at the access time (with films, for example, on the basis of the classification). To dynamically determine the access rights during an access, the filter 9 needs the current data (dynamic magnitudes) which represent additional information (current times, cost survey at the time of access, etc.). The filter monitors the change of the access rights and causes the access rights to be withdrawn. If the access rights change during the access, for example, the maximum time for the use of the television set has elapsed, the filter is to cause the access rights to be withdrawn (FIG. 5). Before that, the filter in this example would give the user a warning that the end of the remaining time is near, or inform him of the remaining time already at the beginning of the use.

FIG. 3 clarifies the function of the filter. During a use an application 10 is started by a user of the network. Via a request in the form of a method 11 to a resource manager 12, which manager provides the withdrawal of the access rights to the resources managed by it, the application 10 requests the necessary resources. The number of all the different method calls and responses are represented by the double arrows referred to as 11 and is simply denoted as method 11 in the following. Similarly, the arrows represented by references 13 represent the number of all the different messages and are simply denoted as message 13. The resource manager 12 sends a request in the form of a method 11 to an access right manager 8 whether an access of the user is permissible or not. With the aid of a structural arrangement of objects 14 in the form of a tree 15 (FIG. 6), which is inside the access right manager 8, the access rights of the user to a selected object 14 are checked. If the access right manager 8 detects that the use of a filter 9 is necessary, this filter is started via a method 11. The result of the filter 9 is supplied in the form of a method 11 to the application 10. If the acknowledgement of the access rights has reached the resource manager 12, the latter starts with a method 11 a device manager 16 which, in contrast to the resource manager 12, is generally responsible for managing the devices without testing their access rights. The device manager 16 reserves, via a method 11, a desired object 14 and sends a respective response about the reservation status via a method 11 to the resource manager 12. If the access rights change during the access, because of the change of certain data (for example, time, cost of use), the filter 9, which is continuously informed of certain events (for example, time etc.) in the network, sends a message 13 to the access right manager 8 which in its turn informs the resource manager 12.

In FIG. 4 is described the time sequence of the actions during a resource reservation. To reserve a resource, the application (AP) 10 makes a request 17 to the resource manager (RM) 12. Before the reservation takes place, the access rights of the user to the object 14 are to be checked. For this reason, a further request 18 which includes, for example, the kind of intended use, is made to the access right manager (ZM) 8. After the access right manager 8 has established that the access rights for the requested object are to be determined by means of a filter, the activation 19 of the filter (FI) 9 is seen to. Via a method 20 a respective response from the access right manager 8 is signaled to the resource manager 12. With a request 21 to the device manager (GM) 16, the actual reservation is started. Device manager 16 sends a reservation instruction 22 to the object (OB) 14. The object 14 sends to the device manager 16 a reservation status 23, which is transferred to the resource manager 12. The resource manager 12 informs via a message 24 the access right manager 8 about the reservation (allocation) of the resource. This message 24 is transferred to the filter 9. Via a message 25 the resource manager 12 informs the application 10 of the successful reservation.

FIG. 5 represents the time sequence of the actions that lead to the withdrawal of the access rights during an access. The filter 9 generates a message 26 which signals a change of the access rights and sends this message to the access right manager 8. Subsequently, the access right manager 8 informs the resource manager 12 of a change of the access rights. The resource manager 12 arranges for a renewed check of the access rights to be made, to find out how the access rights have changed. The resource manager 12 sends a message 27 to the access right manager 8, which makes a respective request 28 to the filter 9. The filter 9 detects that no access is allowed any more and sends a withdrawal 29 to the access right manager 8, which transfers the withdrawal 29 to the resource manager 12. The resource manager 12 informs via a message 30 the access right manager 8 of the release of the resource. The access right manager 8 in its turn informs via a message 31 the filter 9 of the release of the resource. Furthermore, via a message 32 the application 10 is informed by the resource manager 12 that the access is no longer possible. The device manager 16 is instructed by the resource manager 12 via a request 33 to release the resource. The device manager 16 sends a respective message 34 to the object 14.

In FIG. 6 is represented, for example, the tree 15. It consists of a plurality of nodes 35 to 44 in which is found a list of access rights for individual users or user groups, which list belongs to a certain object 14. The nodes are arranged hierarchically which means that if the user was not found in a certain node of an object 14, but in the node lying above it, the access rights of the upper node are valid. The user has access to the object 14 of the lower node.

In this example, the top node 35 of the tree 15 contains the list of permitted users of all the limited-access objects 14 (ACO). The nodes lying below node 35 contain each the permitted users of all the devices (DE), node 36, of all the applications (AP), node 37 and of all the contents (CO), node 38. The node 39 lying below node 36 contains the list of all the permitted users of all the tuners (TU). In this example there are two tuners and, therefore, the nodes 40 of a first tuner (TU1) and node 42 of a second tuner (TU2) lie below node 39 with their respective list of permitted users of the first and second tuner, respectively. Below node 38 there is the node 42 with the list of all the permitted users of the contents in each television program (CH). The node 43 lying below node 42 contains the list of the permitted users of the first program (PR1) and the node 44 of the second program (PR2) contains the permitted users of the second program. A user (for example, Max) would like to watch television (for example PR1, which is available via the first tuner (TU1)). The application 10 detects that a certain resource is necessary for executing the desired application and therefore sends a request to reserve the respective resource in the form of a method call to the resource manager 12. Since the tuner (TU1) is an access controlled object, the resource manager 12 causes the access right manager 8 to check the access rights in that it sends a method call together with the type (of use here) of the desired application to the access right manager 8. The access right manager 8 utilizes said tree 15 for determining the access rights and checks whether Max is stated in the list of the nodes 40. If this is the case, and the access right manager 8 detects that the access rights for tuner (TU1) are to be determined with the aid of the filter 9 (for example, because Max is allowed to utilize the television set only for one hour a day), the filter 9 is activated by the access right manager 8 via a method call and asked for valid access rights. If Max is not stated in the node 40, his name will be searched for in the node 39 lying over it. This operation is repeated until the name Max is found in a node, or the operation is terminated at the upper node. If the name occurs in one of the upper nodes, the access rights of the top node is valid. If the desired access is valid, just like in this example, the filter 9 sends a respective message via the access right manager 8 to the resource manager 12. With this message the filter 9 signals that it is a dynamic access right, which may change in the course of time. With the aid of the device manager 16 the resource manager 12 reserves the desired object 14. The object 14 informs the device manager 16 of the reservation status via a message and this device manager 16 transfers this message to the resource manager 12. The resource manager 12 informs both the application 10 and the access right manager 8 and the latter informs the filter 9 of the successful reservation of the object 14.

1. A network comprising terminals and a software system distributed over all the terminals, characterized
in that the network comprises at least an access controlled object (14) and
in that the software system includes at least a filter (9) which is provided for evaluating the access rights of a user for an access controlled object (14) based on data which are not available until the time of access.

2. A network as claimed in claim 1, characterized
in that during the access to the access controlled object the filter (9) is provided for evaluating additionally occurring data, and
in that the filter is provided for monitoring the change of the access rights and for triggering the withdrawal of the access rights to the access controlled object.

3. A network as claimed in claim 2, characterized in that in the software system, after an application (10) has been used, a method (11) provides a software component referred to as resource manager (12) for withdrawing the access rights.

4. A network as claimed in claim 3, characterized in that the software system includes a software component referred to as access right manager (8) which, together with the filter (9), is instructed by the resource manager (12) to check the access rights.

5. A network as claimed in claim 4, characterized
in that the access right manager (8) has a data structure in the form of a tree (15) for arranging access controlled objects (14) and
in that the tree (14) includes a plurality of nodes (35 to 44) which each contain a list of permitted users or user groups respectively, of an access controlled object and for each user or user group respectively, include a list of methods of use.
